(19) United States
(12) Patent Application Publication
(10) Pub. No.: US 2008/0141685 A1
(43) Pub. Date: Jun. 19, 2008

(54) Method, Apparatus And Cooling Element For Cooling Carcass Parts

(75) Inventors: Uffe Borup, Ringsted (DK); Ole Damgaard, Hvidovre (DK)

Correspondence Address: SUGHRUE MION, PLLC, 2100 PENNSYLVANIA AVENUE, N.W., SUITE 800, WASHINGTON, DC, 20037, US

(73) Assignee: SLAGTERIERNES FORSKNINGSINSTITUT, ROSKILDE (DK)

(21) Appl. No.: 11/814,120

(22) PCT Filed: Feb. 13, 2006
(86) PCT No.: PCT/DK06/00082

§ 371 Date: Jul. 17, 2007

(30) Foreign Application Priority Data
Feb. 16, 2005 (DK) PA 2005 00234

(51) Int. Cl. A23B 4/06; A22C 15/00

(52) U.S. Cl. 62/62; 452/185

(57) ABSTRACT

An apparatus for cooling carcass parts (1) comprises at least one cooling element (8, 9) with a flexible cooling surface (14) for abutment with a carcass part (1); a form-stable shell (15); and a cavity (17) behind the flexible cooling surface (14), through which cavity refrigerant can flow from an inlet to an outlet. The apparatus also comprises a moving device (13) for moving the cooling element (9) for abutment of the cooling surface (14) with the carcass part (1).

This invention relates to a method for cooling carcass parts by means of a refrigerant that flows along one side of sheeting, whose other side is in abutment with a carcass part.

The invention also relates to an apparatus for cooling carcass parts.

Finally, the invention relates to a cooling element for cooling carcasses.

A method of the above type is known from DK 173153 B1 (Danish Meat Research Institute) which relates to a method and a system for cooling warm pig carcasses, in which carcass parts, especially split half pig carcasses, are wrapped in sheeting and immersed in a vessel with flowing refrigerant. After cooling, the sheeting is removed from the carcass parts.

Use of this known method is impractical as an open vessel with a large refrigerant capacity is required and as the wrapping in sheeting and transport of the carcasses into and up from the vessel are laborious procedures.

U.S. Pat. No. 2,254,406 discloses a cooling apparatus comprising a rack with fixed shelves with bags inflatable by refrigerant, e.g. brine, to cool foodstuff items laying on the shelves. In order to place or remove the items the bags must be emptied of refrigerant. This is unpractical, as relative large quantities of refrigerant must be stored elsewhere, when the bags are empty, and the bags must contain a large volume of refrigerant, which only slowly may be exchanged for regulating the cooling process.

The object of the present invention is to provide a solution that is more practical to use.

This is achieved by a method which is characterized in that at least one cooling element with a cavity for refrigerant between a flexible cooling surface and a wall behind it is moved to bring the flexible cooling surface of the cooling element into abutment with the carcass part; in that refrigerant is made to flow through the cavity in order to cool the carcass part by way of the cooling surface; and in that the cooling element is moved away from the carcass part after cooling. By using such cooling elements, the amount of refrigerant can be reduced, as the presence of refrigerant can be limited to the areas in close proximity to the carcass part. The cooling elements are preferably designed so as to envelop the carcass part and ensure a relatively uniformly thick layer of refrigerant around the carcass part. The cooling process is simply initiated by bringing the cooling elements into abutment with the carcass parts so that a substantial part of their surface comes into contact with the cooling elements, which is significantly less demanding than sheeting wrapping and hoists for carcass parts.

Cooling usually takes place after the carcass parts have been subjected to veterinary inspection. It is therefore not necessary to clean the cooling surface or other parts after each cooling operation.

The invention is not limited to one particular refrigerant; however, use is preferably made of a refrigerant in the form of brine or slush ice with a high cooling capacity and high thermal conductivity, enabling the use of higher working temperatures than in the commonly used tunnel cooling for cooling warm carcasses as the heat transmission by the method according to the invention is much higher than for cooling by air.

As used herein, brine means aqueous solutions of solids, e.g. salts; or mixtures of water and organic liquids, e.g. glycols or alcohols (or combinations of solutions and mixtures). Brine has the ability of being frost-proof at temperatures below 0° C. and for instance being able to operate at −7° C .without freezing.

Brine removes the heat of the product by increase in temperature and must therefore be cooled by means of a cooling system. Brine is advantageous in that it is easy to cool in an outer cooling system.

As used herein, slush ice means either an aqueous solution of solids, or a mixture of water and organic liquids containing an ice portion in the form of particles (or combinations of solutions and mixtures with ice particles). Slush ice has the ability of remaining capable of flowing at temperatures below 0° C. (at the working temperature). Preferably, the slush ice does not contain ice portions big enough to prevent it from being easy flowing and easily pumpable. Slush ice with fine ice particles that stay floating is preferably used, see e.g. WO-A1-9627298 (Danish Technological Institute).

Slush ice removes the heat from the product by phase change from ice to water and thus has a large cooling capacity. Slush ice has excellent thermal properties (latent heat of fusion) and also displays good mixing abilities (remains homogeneous and fluidized). Slush ice can be pumped with traditional centrifugal pumps.

Binary mixtures of slush ice are in practice zeotropic, i.e. phase change from solid to liquid form takes place within a temperature interval.

According to the invention it is preferred that the refrigerant, in the form of brine or slush ice, operates in a temperature range between −2 and −20° C. The temperature of the refrigerant is preferably between −4 and −12° C.

By using low temperatures for the refrigerant, shell freezing of the carcass part can be achieved, which is advantageous in various respects. At refrigerant temperatures below −12° C. there is, however, a risk of cold shrinkage in the loin when cooling split half pig carcasses from slaughter pigs with an average weight of 76 kg. For fatter slaughter pigs lower temperatures can be employed. For slaughter pigs with an average weight of 76 kg it is preferred to have a refrigerant temperature at the inlet of the cooling element at or just above −12° C.

When cooling part of a carcass, e.g. half a split pig carcass, the aim is usually a specific temperature reduction, e.g. from about 37° C. to about 6° C. Cooling depends on various parameters, such as the cooling time, the weight of the carcass part, the cooled area, the temperature of the refrigerant, and the heat transfer coefficient, which again depends on various parameters. In particular, the weight of the carcass parts varies due to variation in the size of the slaughter animals. Moreover, the lean meat content varies from animal to animal. According to the invention it is therefore preferred to cool for a predetermined period of time and that this period, the cooling time, be predetermined depending on the weight and lean meat content of the actual carcass part.

In one embodiment, slush ice with an ice portion of not more than 35 percent by weight, preferably 10-30 percent by weight, is used.

The brine or the slush ice may contain NaCl.

The brine or the slush ice may contain 5-25 percent by weight of ethanol.

The brine or the slush ice is preferably cooled in a single-stage cooling system.

The object of the invention is also achieved by an apparatus as mentioned above, said apparatus being characterized in that it comprises at least one cooling element with a flexible cooling surface of sheeting for abutment with a carcass part; a form-stable shell; and a cavity behind the flexible cooling surface, through which refrigerant can flow from an inlet to an outlet; and in that it comprises a moving device for moving the cooling element for abutment of cooling surface with the carcass part. Such an apparatus is suitable for an automated process.

In a preferred embodiment, the cavity has a uniform thickness, preferably 2 to 30 mm, more preferably 5 to 10 mm; and at least the cooling surface, and possibly also a wall behind it of the cavity, consists of sheeting. The little thickness or width of the cavity entails that the content of refrigerant is small, which entails that a large flow rate may be provided for, which facilitates regulation of the cooling process, as the content of refrigerant may quickly be changed in respect of temperature and composition in order to change the heat transmission between the carcass part and the refrigerant. It is thus possible to cool at different rates at different times during the cooling process. It is e.g. possible initially to cool at a high rate and thereafter let the temperature of the carcass part equalize to some degree and finally cool at an intermediate of the refrigerant.

In an embodiment, there are one or more spring units in between the shell and a cavity wall behind the cooling surface, which press the cooling surface against the carcass part after the moving device has brought the cooling surface into contact with the carcass part. Such a spring unit may help transfer pressure from the shell to the cavity wall opposite the cooling surface and distribute such pressure on this wall, whereby the distributed pressure is transferred through the refrigerant to the cooling surface which is thereby pressed against the surface of the carcass part to follow its shape.

The spring unit may comprise a gas pressurized hollow space, wherein the side facing the cooling surface is of a flexible material. Said hollow space may have at least one connection element for connecting a compressed gas/air source. It is thus possible to regulate the filling, if desired, of said cavity and thus the distance between the shell and the cooling surface. Furthermore, it is possible to regulate the force with which the cooling surface is in abutment with the carcass part.

In another embodiment, the wall behind the cooling surface is constituted by or is in close contact with the shell.

In an embodiment, the apparatus comprises several of said cooling elements, and the moving device bringing the cooling surfaces into abutment with the carcass part comprises power elements for mutual movement of the cooling elements between an open position, in which the carcass part can be introduced between the cooling elements, and a closed position, in which the cooling elements can envelop the carcass part, the cooling surfaces being in contact therewith. This embodiment with several cooling elements can also be used when there is a gas-pressurized cavity between the shell and the wall of the cavity for refrigerant opposite the cooling surface.

Preferably, in an inactive position, the shape of the cooling surface, any spring units and/or the shell is approximately adapted to the shape of the corresponding part of the carcass part to be cooled. E.g. the shell may be formed as a, possibly roughly, stylized carcass. It is thus not necessary to make big variations in filling the cavity and/or in the cavity in order to fill out the space between the shell and the surface of the carcass so as to ensure substantially complete abutment of the cooling surface with the carcass part.

Although the largest cooling effect is achieved if 100% of the surface of the carcass part is covered by or in contact with the cooling surface(s), a fully satisfying cooling process is in practice achieved with less than 100% of the surface of the carcass part being covered, particularly when the not covered surfaces are extremities, such as legs. It is, however, preferred that the degree of coverage is at least 85%.

The shell preferably comprises a layer of thermal insulating material on an inner and/or outer side in order to avoid unnecessary cold loss to the environment. If use is made of a spring unit in the form of a gas pressurized cavity, the layer need not be as thick as otherwise as the cavity has an insulating effect.

To ensure a good distribution of the refrigerant, the cavity is preferably designed with channels for refrigerant to flow through. The cavity of the cooling element is thus preferably divided into several horizontal channels that are provided with refrigerant by way of a manifold inside or outside the cooling element.

There may exist means for holding a carcass part suspended while one or more cooling elements are in abutment with the carcass part.

In an embodiment suitable for cooling split half pig carcasses, said apparatus may comprise means for holding a gambrel, in which two half pig carcasses are suspended in pairs by the hind legs.

For the cooling surface there may, for instance, be used plastic, textile or rubber sheeting or film with thicknesses of up to 1 mm. Plastic and textiles have heat-conducting properties that largely correspond to those of the carcass part. This means that the cooling surface or sheeting in a thermophysical context, only adds to the carcass parts with the sheeting thickness, provided that the sheeting sits closely to the surface. A polyethylene sheeting with a thickness of 0.15 mm is shown to have sufficient strength and flexibility to be able to stretch over carcass parts with protruding legs, e.g. half pig carcasses with severed head. Polyethylene is the most commonly used material for wrapping meat and meat products.

It is important that the materials chosen are sufficiently chemically stable and can be approved for use in the food industry. The materials chosen must also have sufficient mechanical stability.

After cooling, a gambrel with half carcasses may be transferred to the usual slide rail or transport conveyor of the slaughterhouse and forwarded to an equalization room for equalizing temperature differences.

The refrigerant circuit with which the apparatus is connected must preferably be able to ensure a flow rate through the refrigerant cavity of at least 0.02 to 0.2 m/s, more preferably at least 0.05 m/s.

As used herein, carcass part means, e.g. a carcass, a half carcass or a part of a carcass. A carcass part may thus be a warm half carcass, e.g. a half pig carcass. As used herein, carcass part may also mean, e.g. a meat item obtained from processed meat products, such as cold meats, e.g. cooking ham, saveloy sausage and rolled meat sausage.

The invention may be used for cooling meat items that must be cooled, after-cooled, shell frozen or frozen (e.g. in connection with slicing of the item).

The meat items may be wrapped in sheeting.

In the following, the invention will be explained in more detail by means of an embodiment, with reference to the schematic drawings in which

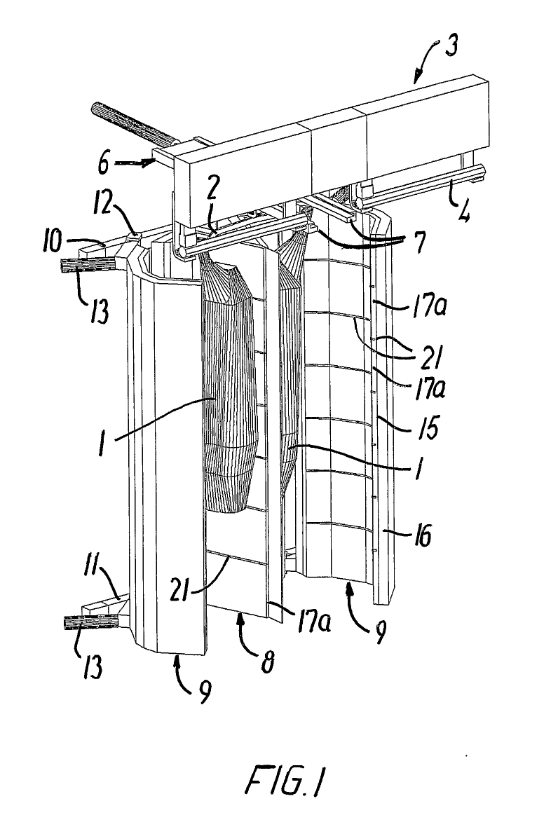

FIG. 1 shows two half pig carcasses in an apparatus according to the invention seen from above at an angle,

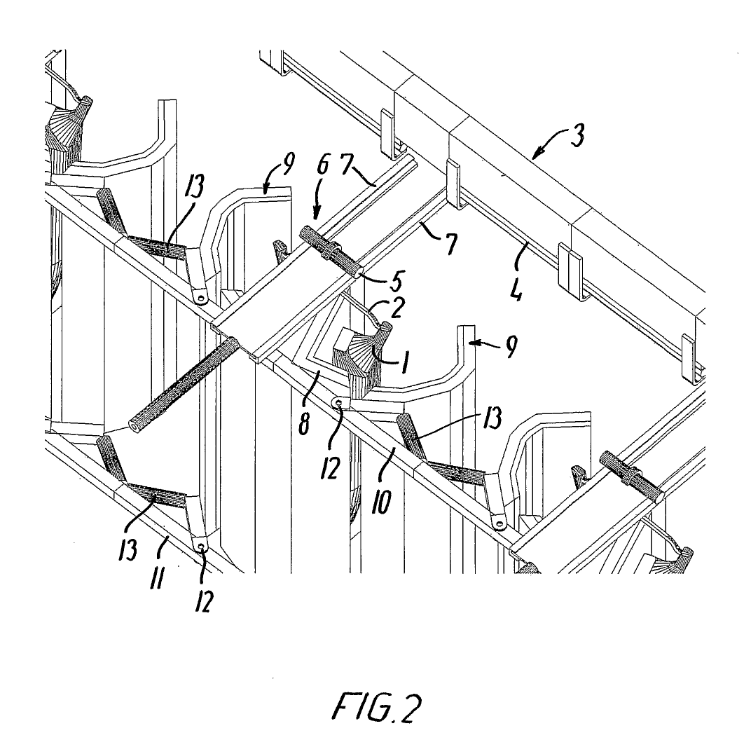

FIG. 2 shows the same but seen from above from another angle,

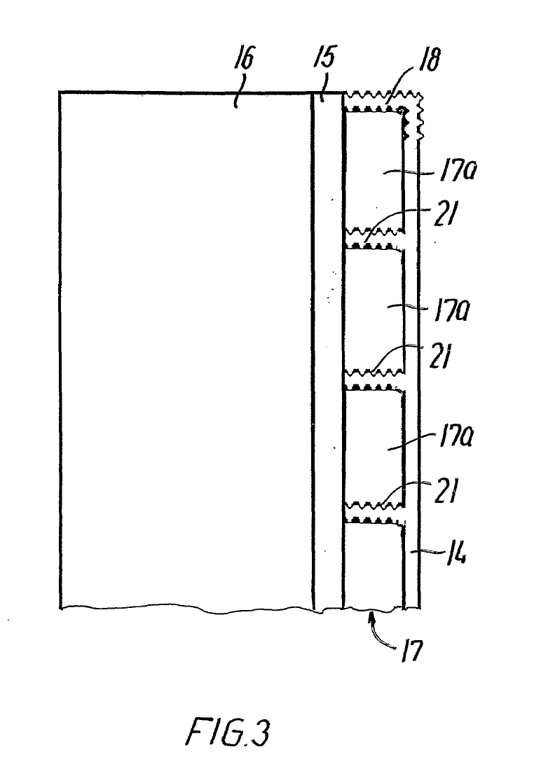

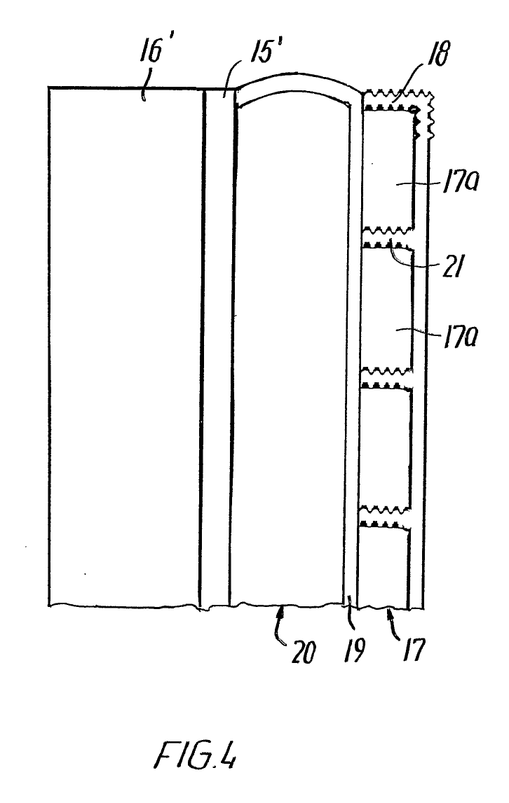

FIGS. 3 and 4 show schematic sections of part of a cooling element in different embodiments.

FIGS. 1 and 2 show two half pig carcasses or carcass parts 1 hanging in a gambrel 2. A common slide rail conveyor 3 for gambrels 2 has a slide rail 4 with a loose section 5 that can be moved sideways by means of a mechanism 6 known per se, wherein section 5 rests on tracks 7 that together with the section 5 and the gambrel 2 thus constitute means for holding the carcass parts 1 suspended in the hind legs.

In FIGS. 1 and 2, the carcass parts 1 are located between respective pairs of hollow cooling elements 8 and 9, which are suspended from two horizontal beams 10 and 11. The first cooling elements 8 are rigidly mounted (but may also be movably mounted) and together they have an overall wedge configuration, as particularly seen in FIG. 2. The second cooling elements 9 are hinged on beams 10 and 11 by hinges 12, so that they, by means of cylinders 13, may swing against and away from the first cooling elements 8 between a closed position and an open position, in which the carcass parts are enveloped and released, respectively. FIGS. 1 and 2 show the second cooling elements 9 in the open position.

The two pairs of cooling elements 8 and 9 are preferably equal but mutually mirror-inverted. The first cooling elements 8 are designed to abut the inner side of the carcass part 1 and the second cooling elements 9 are designed to abut the outer side or the rind side of the carcass part 1.

Except from their shape and dimension in the horizontal plane, the cooling elements have, or they may have, substantially the same construction, which will now be described with reference to one of the cooling elements 9 and FIG. 3.

The cooling element has a cooling surface 14 of a flexible material, preferably polyethylene in the form of a sheeting with a thickness of e.g. between 0.15 mm and 1 mm. Behind the cooling surface 14, see FIG. 3, there is a form-stable shell 15, which is shaped corresponding to the surface of a carcass which the cooling element is intended to abut. The shell 15 may for instance be made of 3 mm aluminium plate with external rib reinforcement. Externally, the cooling element is provided with an insulation layer 16 to avoid cold loss.

In the embodiment in FIG. 3, the shell 15 constitutes a wall opposite the cooling surface, which wall together with the cooling surface 14 defines a cavity 17 through which a refrigerant can circulate.

The material of the cooling surface 14 is connected with the shell 15 and, near said connection, has a pleated or corrugated expansion area 18 to allow expansion of the cavity 17 and a certain mobility of the cooling surface 14 relative to the shell 15.

The cooling surface 14 may just like the shell 15 be shaped corresponding to the surface of a carcass, which the cooling element is intended to abut. The expansion area 18 and the flexibility of the cooling surface 14 may compensate for variations between different carcasses.

FIG. 4 shows a variant of the construction of a cooling element, wherein, contrary to the embodiment in FIG. 3, there is an independent wall 19, preferably of a flexible material, so that there is a hollow space 20 between the wall 19 and a shell 15′. The hollow space 20 enables greater mobility of the cooling surface 14 relative to the shell 15′ than is the case with the first embodiment. The hollow space 20 furthermore enables movement of the cooling surface 14 relative to the shell 15′ substantially without simultaneously changing the cross section of the cavity 17. An insulation layer 16′ is thinner than the insulation layer 16 in the embodiment in FIG. 3 because said hollow space 20 also contributes to insulation.

The hollow space 20 may for instance be filled with air. It may be closed and have a certain filling, or it may be provided with connection through a valve to a source of compressed air and an outlet/return for enabling regulation of the filling and the pressure in said hollow space. The hollow space 20 may thus function as a (air) spring unit.

As shown in FIGS. 1, 3 and 4, the cavity 17 is preferably divided into horizontal channels or sections 17a that are separated by single or double partitions 21. In the case of single partitions 21, as shown in FIGS. 3 and 4, the material of the cooling surface 14 will be unbroken from top to bottom. In the case of double partitions 21, the material of the cooling surface 14 may take the form of horizontal lengths. The material of the partitions 21 is in the embodiment shown pleated or corrugated just like the expansion area 18 and for the same reason.

The sections 17a of the cavity 17 have a connection, not shown, to a cooling circuit for refrigerant through an inlet manifold, not shown, at one side of the actual cooling element 8, 9 and an outlet manifold at the opposite side of the cooling element 8, 9.

The apparatus operates as follows:

A carcass 1 in two parts is, after veterinary approval, conveyed by a slide rail conveyor 3 to a position, wherein the slide rail 4 of the conveyor has a loose section 5 next to a cooling apparatus with the cooling elements 8, 9. By means of the mechanism 6, the slide rail section 5 is led sideways, whereby the half carcasses 1 suspended from the gambrel 2 are brought in between a pair of cooling elements 8 and 9, respectively. By the relative movement between the half carcasses 1 and the cooling elements 8, 9, the first cooling elements 8 push in between the half carcasses 1 like a wedge, said half carcasses coming into abutment with the first cooling elements 8 with their inner side opposite the rind side. Subsequently, the cylinders 13 are activated, whereby the second cooling elements 9 swing in their hinges 12 to the mutually closed position for the cooling elements 8, 9.

Via the cooling circuit, for instance sodium chloride containing brine with a temperature of −12° C. is circulated through the cavity sections 17a. On circulation of about ⅓ l/s, a half carcass of a slaughter pig with a weight of 76 kg can be cooled from an average temperature of 37° C. to an average temperature of 6° C. over about 55 minutes with a cooling of the brine of about 1 to 2° C. This can be achieved by a flow rate of at least 0.02 to 0.2 m/s, e.g. about 0.05 m/s, when the height of the cooling elements and thus the cavity 17 is about 2 m and the width b of the flow cross section in said cavity 17 is between 2 and 30 mm, e.g. about 6 mm.

By this method shell freezing will be achieved after 55 minutes of the outer area of the carcass parts 1, which can therefore be brought to an equalization room for equalizing the temperature in the carcass parts 1. With a cooling process of more than 55 minutes, shell freezing can be avoided if it is undesirable.

In the embodiment of the construction of the cooling elements, illustrated in FIG. 3, the cavity may for instance expand about 2.5 mm in thickness. In the embodiment illustrated in FIG. 4, it is possible to omit the pleating or corrugation in the expansion area 18 and instead leave the material in this area smooth as the required expansion of the space between the shell 15 and the cooling surface 14 takes place in the hollow space 20.

In the embodiment of the construction of the cooling elements, illustrated in FIG. 3, the cylinders 13 must be activated by a predetermined force in order not to risk the cavity 17 being compressed in areas so that no cooling effect is achieved in such areas. In the embodiment with adjustable filling of the hollow space 20, illustrated in FIG. 4, there exists a possibility of swinging the second cooling elements 9 into a predetermined closing position and then pressurizing the hollow space with a predetermined pressure that cannot exceed the pressure in the cavity in order not to risk compressing it. The cooling elements are shaped according to the carcass parts they are to cool and can for instance tolerate a differing body weight of 5 kg without reduction in their efficiency. The shape may lie in the shell (aluminium plate) and/or in the shape, which the cooling surface takes when pressed against the carcass part. If there is a gas pressurized hollow space, this also contributes to shape adjustment, so that abutment becomes very close.

In a slaughterhouse there will have to be a large number of cooling apparatuses to keep up with the rate of the slaughterline. The cooling apparatuses may advantageously be arranged in groups, wherein different groups can receive groups of carcasses correspondingly divided into weight classes, so that carcasses with substantially the same weight are cooled in one group, whereby all carcasses in one group have the same required cooling time, in order to achieve the same average temperature, provided that a cooling circuit provides all cooling apparatuses in a group with refrigerant of uniform temperature. The actual temperature and the correspondingly required cooling time, which depends on the average weight of a given group, can be calculated from different criteria, e.g. whether or not shell freezing is desired. The carcasses may also be divided in groups depending on their lean meat content as low lean meat content requires a longer/stronger cooling process, and vice versa.

When the cooling apparatuses are arranged in weight class/lean meat content groups, gambrels 2 with half carcasses 1 can be brought to a position next to their respective cooling apparatus, until a group is full, as the gambrels 2 hang on their respective loose slide rail section 5. Then the individual half carcasses can be brought into their respective cooling apparatuses that are closed, after which cooling commences at the same time in the entire group. After cooling, the cooling apparatuses are once again opened, the cooling elements being brought to their open positions, after which sections 5 are brought back to the slide rail 4 and the cooled carcasses are brought to an equalization room.

It is also possible to control each cooling apparatus individually. In this case, the slide rail conveyor 3 is preferably arranged so that the loose sections 5 are replaced when a section 5 is brought sideways to a cooling apparatus. The slide rail 4 will thus always be intact, and carcasses can be brought past a cooling apparatus in use so that use of a single cooling apparatus does not affect the use of the other cooling apparatuses. In such an embodiment each cooling apparatus may be provided with means for controlling the supply temperature of refrigerant supplied to the respective apparatus, and each cooling apparatus can be controlled in relation to the temperature of the refrigerant and the cooling time depending on the weight, and possibly the lean meat content, of actual carcass parts to be cooled. The means for controlling the supply temperature may for instance, in a manner known per se, comprise a shunt valve.

With the cooling apparatus according to the present invention it is possible to divide the cooling process into different phases, e.g. by initially cooling quickly for e.g. half an hour to a mean temperature of each carcass of 10-15° C., thereafter allowing the temperature to equalize for 2-10 hours at a refrigerant temperature of 10-15° C., i.e. substantially without further cooling during the equalization phase or period, and finally cooling for e.g. 1 hour to a mean temperature of the carcass below 7° C. at a refrigerant temperature of e.g. 4-5° C.

When the invention is used in connection with cooling of smaller meat items than half carcasses, they may lie on the cooling surface of cooling elements, and/or cooling elements may be brought down into squeezing abutment with the items, e.g. items in a meat box.

1. A method for cooling carcass parts by means of a refrigerant that flows along one side of a sheeting, whose other side is in abutment with a carcass part, wherein at least one cooling element with a cavity for refrigerant between a flexible cooling surface and a wall behind it is moved to bring the flexible cooling surface of the cooling element into abutment with the carcass part; refrigerant is made to flow through the cavity in order to cool the carcass part by way of the cooling surface; and the cooling element is moved away from the carcass part after cooling.

2. A method as claimed in claim 1, wherein the cooling element is held in abutment with the carcass part for a predetermined period of time, while refrigerant is flowing through the cavity in accordance with a predetermined schedule.

3. A method as claimed in claim 2, wherein the duration of the period is determined relative to the weight and/or lean meat content of the carcass.

4. A method as claimed in claim 1, wherein a mixture of water and an alcohol, preferably ethyl alcohol or ethylene glycol, or an aqueous solution of a salt, preferably NaCl or potassium acetate, which is cooled to a temperature between −2° C. and −20°, preferably between −4° C. and −12° C., is used as refrigerant.

5. A method as claimed in claim 1, wherein the cavity has a uniform thickness, preferably between 2 and 30 mm, more preferably between 5 and 10 mm.

6. A method as claimed in claim 2, wherein the temperature, the flow rate and/or the composition of the refrigerant is varied during the period of time.

7. An apparatus for cooling carcass parts comprising at least one cooling element with a flexible cooling surface of sheeting for abutment with a carcass part; a form-stable shell; and a cavity behind the flexible cooling surface, through which refrigerant can flow from an inlet to an outlet; and comprising a moving device for moving the cooling element for abutment of the cooling surface with the carcass part.

8. An apparatus as claimed in claim 7, wherein the cavity has a uniform thickness, preferably between 2 and 30 mm, more preferably between 5 and 10 mm, and in that at least the cooling surface, and possibly also a wall behind it of the cavity, consists of sheeting.

9. An apparatus as claimed in claim 7, wherein there are one or more spring units in between the shell and cavity wall behind the cooling surface, which press the cooling surface against the carcass part after the moving device has brought the cooling surface into contact with the carcass part.

10. An apparatus as claimed in claim 9, wherein a spring unit comprises a gas pressurized hollow space, wherein the side facing the cooling surface is of a flexible material.

11. An apparatus as claimed in claim 10, wherein said hollow space has at least one connection element for connecting a compressed gas/air source.

12. An apparatus as claimed in claim 7, wherein the cavity wall behind the cooling surface is constituted by or is in close contact with the shell.

13. An apparatus as claimed in claim 7, comprising several of said cooling elements, the moving device bringing the cooling surfaces into abutment with the carcass part comprising power elements for mutual movement of the cooling elements between an open position, in which the carcass part can be introduced between the cooling elements, and a closed position, in which the cooling elements can envelop the carcass part, the cooling surfaces being in contact therewith.

14. An apparatus as claimed in claim 7, wherein in an inactive position, the shape of the cooling surface, any spring units and/or the shell is approximately adapted to the shape of the corresponding part of the carcass part to be cooled.

15. An apparatus as claimed in claim 7, wherein the shell on an inner and/or outer side comprises a layer of thermal insulating material.

16. An apparatus as claimed in claim 7, wherein the refrigerant cavity is designed with channels for refrigerant to flow through.

17. An apparatus as claimed in claim 16, wherein the cavity of the cooling element is divided into several horizontal channels that are provided with refrigerant by way of a manifold inside or outside the cooling element.

18. An apparatus as claimed in claim 7, comprising means for holding a carcass part suspended while one or more cooling elements are in abutment with the carcass part.

19. A cooling element for cooling a carcass part, comprising a flexible cooling surface of sheeting for abutment with a carcass part; a form-stable shell curved or bent in direction of the cooling surface; and a cavity behind the flexible cooling surface through which refrigerant can flow from an inlet to an outlet.
